(19) United States
(12) Patent Application Publication
(10) Pub. No.: US 2004/0101543 A1
(43) Pub. Date: May 27, 2004

(54) Nicotine-containing oral dosage form

(76) Inventors: John Liu, Parsippany, NJ (US); Stanley J. Lech, Parsippany, NJ (US); Stuart Platcow, Parsippany, NJ (US)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/471,477

(22) PCT Filed: Mar. 22, 2002
(86) PCT No.: PCT/US02/08914

(51) Int. Cl. A01N 43/04

(52) U.S. Cl. 424/434; 514/54

(57) ABSTRACT

The present invention is directed to glassy matrix solid oral dosage forms useful for transmucosal oral administration of a nicotine active.

### FIELD OF THE INVENTION

The present invention relates to solid, oral dosage forms comprising a nicotine active, which are useful for reducing or preventing nicotine cravings by oral transmucosal delivery of the nicotine active. The invention also relates to methods of using such compositions for reducing or preventing nicotine cravings or tobacco usage.

### BACKGROUND OF THE INVENTION

It is generally known that active as well as passive smoking of tobacco products, such as cigarettes, cigars, and pipe tobacco, presents serious health risks to the user and those subjected to secondary smoke. It is also known that use of other forms of tobacco, such as chewing tobacco, presents serious health risks to the user. Furthermore, the use of tobacco products in public areas is increasingly either restricted or socially unacceptable.

It is also recognized that reducing or quitting tobacco use is often very difficult for persons accustomed to using tobacco. This difficulty arises in large part from the addictive nature of nicotine. Efforts have therefore been made to provide nicotine substitutes to satisfy a tobacco user's cravings, but which avoid health risks associated with tobacco use, especially smoking.

In recent years, nicotine replacement therapies (NRT) have been successfully commercialized as a means to reduce or quit smoking or other forms of tobacco usage. Such commercial NRT include nicotine gums (e.g., NICORETTE) and nicotine transdermal patches (e.g., NICODERM). While such means are useful as aids to reduce or quit smoking, there is an ongoing need to provide improved or alternate NRT. For example, users may prefer to use forms other than chewing gum or transdermal patches. Certain users may dislike or be unable to chew gum, and users may desire more rapid craving relief than typically provided by transdermal patches.

In addition, nicotine lozenges have been marketed outside of the United States, for example, as STOPPERS and NICOTINELL brand lozenges. As far as the present inventors are aware, such lozenges are in the form of compressed tablets. In addition, U.S. Pat. Nos. 5,593,684; 5,721,257 and 5,362,496 (Baker et al.) disclose methods and therapeutic systems for smoking cessation, utilizing transdermal nicotine delivery for obtaining base-line nicotine plasma levels, coupled with transmucosal administration of nicotine to satisfy transient craving. One preferred transmucosal delivery system is a lozenge for buccal delivery, comprising nicotine dispersed in an absorbent excipient and a nonnutritive sweetener, preferably made by direct compression.

While providing a potential alternate NRT form, such compressed lozenges may not be appealing to certain users for performance or esthetic reasons. For example, compressed tablets tend to have a relatively grainy texture. In addition, commercial tablets of which the present inventors are aware are designed to have a relatively long dissolution period, such that craving relief is not as rapid as might be desired.

Nicotine confectionary forms are disclosed in U.S. Pat. Nos. 6,082,368 (Brown) and 5,048,544 (Mascarelli et al). Brown discloses a nicotine candy in a cigarette shaped package. The candy may use beta-pyridyl-alpha-N-methyl pyrrolidine or powdered tobacco leaves dissolved or dispersed in any standard hard sugar candy. Examples of sugars for making the hard candy include corn sugar, table sugar, and the sugar-free substitute, Lycasin. Mascarelli et al. discloses a cigarette substitute having an edible portion with nicotine, e.g., in the form of a conventional lollypop preferably with a hard or semi-hard candy.

The present invention relates to novel and improved, nicotine-containing solid oral dosage forms that are useful for reducing or preventing nicotine cravings.

### SUMMARY OF THE INVENTION

The invention relates to a solid, oral dosage form comprising a nicotine active, useful for transmucosal oral administration of the nicotine active. The solid, oral dosage form preferably comprises:

a) a glassy matrix comprising at least one substantially non-hygroscopic sugar alcohol capable of forming a glassy structure; and

b) a nicotine active in an amount effective to reduce nicotine cravings.

In a preferred embodiment, the sugar alcohol is a mixture of 1,6-GPS (6-O-α-D-glucopyranosyl-D-sorbitol) and 1,1-GPM (1-O-α-D-glucopyranosyl-D-mannitol) in a weight ratio of from about 99:1 to about 1:99 (more preferably ISOMALT), and the nicotine active is nicotine, a nicotine derivative, or a combination thereof. Preferred compositions further comprise a buffer which provides an alkaline mouth pH. Lozenges are a preferred dosage form.

The invention also relates to methods of reducing tobacco usage or of reducing nicotine cravings involving oral transmucosal administration of the solid, oral dosage form.

### DRAWINGS

FIG. 1 shows the dissolution profile (% nicotine release vs time) for nicotine polacrilex and nicotine bitartrate lozenges according to the present invention.

### DETAILED DESCRIPTION OF THE INVENTION

All publications, including but not limited to patents and patent applications, cited in this specification are incorporated herein by reference as though fully set forth.

Unless otherwise specified, all parts and percentages set forth herein are weight percentages based on the weight of the relevant composition.

Unless otherwise stated, as used herein, the modifier “a” includes one or more of the components modified.

The present invention may comprise, consist essentially of, or consist of the components set forth below, unless otherwise stated.

The solid, oral dosage form of the present invention preferably comprises:

a) a glassy matrix comprising at least one substantially non-hygroscopic sugar alcohol capable of forming a glassy structure; and

b) a nicotine active, in an amount effective to reduce nicotine cravings.

The composition is orally dissolvable and may be in any form which is typically sucked, licked, and/or chewed and eaten, such as lozenges, sticks, canes, pops, etc. Lozenges are a preferred form. Lozenges of the present invention are oral dosage forms intended to be held in the mouth, and are typically sucked. For example, they may be held in the buccal cavity or sublingually. The lozenges may be in various shapes, including flat, circular, octagonal and biconvex.

The matrix (aka base) is a carrier for the nicotine active and optional adjuvants, and typically comprises from about 50% to about 100% of the composition. The product matrix is in a glassy, i.e., amorphous, physical state. Without intending to be limited or otherwise bound by theory, it is believed that the glassy matrix structure stabilizes nicotine actives such as nicotine and its derivatives, and potentially other components that tend to be unstable to moisture, e.g., by reducing penetration of water into the oral dosage form. The glassy matrix structure also tends to be more esthetically appealing to the user, e.g., providing a desirably smooth, organoleptic feel, which may increase user compliance. In addition, the glassy matrix structure tends to dissolve more rapidly than commercially available compressed nicotine tablets of which the present inventors are aware, thereby providing potentially faster craving relief than such tablets.

Glassy structure can be readily determined by those skilled in the art using conventional techniques such as X-ray diffraction. See, e.g., Settle, Frank A. et. al., Handbook of Instrumental Techniques for Analytical Chemistry, Prentice Hall PTR (1997). The formation of a glassy state is also typically characterized by a transparent appearance. As will be appreciated by those skilled in the art, the physical state is influenced by the properties of the components (especially sugar alcohols and other sugar components), and the process of making the product, and those skilled in the art will be able to select appropriate components and processes.

The non-hygroscopic property of the sugar alcohol is also believed to contribute to the stability of nicotine actives such as nicotine and its derivatives, and potentially other components that may be moisture-sensitive, as well as reducing the tendency of the oral dosage form to tackify upon exposure to humidity. As used herein, the term “substantially non-hygtoscopic” means that the sugar alcohol has a low tendency to absorb water under conditions of 25° C./80% relative humidity (rh) (e.g., a maximum of 50%, preferably a maximum of about 30%, more preferably a maximum of about 20%, even more preferably a maximum of about 10% (e.g., up to about 8%), especially a maximum of about 5% (also up to about 2% or about 1%), weight gain of water upon exposure to conditions of 25° C./80% rh for a period of 2 weeks).

Examples of substantially non-hygroscopic sugar alcohols capable of forming a glassy structure suitable for use in the present invention include a sugar alcohol mixture comprising 1,6-GPS (6O-α-D-glucopyranosyl-D-sorbitol) and 1,1-GPM (1-O-α-D-glucopyranosyl-D-mannitol) in a weight ratio of from about 1:99 to about 99:1, more preferably from about 70:30 to about 30:70, even more preferably from about 40:60 to about 60:40. In a particularly preferred embodiment the ratio is from about 43% to about 57% of 1,1-GPM and from about 57% to about 43% of 1,6-GPS (including about 1:1); for example, the sugar alcohol mixture contained in the product ISOMALT. ISOMALT is particularly preferred in the present invention. Such sugar alcohol mixtures may comprise other sugar alcohols and oligosaccharides, e.g., 1,1-GPS (1-O-α-D-glucopyranosyl-D-sorbitol), sorbitol, or mannitol, preferably in small amounts (e.g., less than about 10%, especially less than about 5%).

Sugar alcohol mixtures suitable for use in the invention are commercially available from Palatinit of America, Inc., of Morris Plains, N.J., USA. Suitable mixtures are also described in EP 0625578 B1.

The substantially non-hygroscopic sugar alcohol serves as a carrier (or bulking agent) for the nicotine actives and optional adjuvants. The solid, oral dosage form typically comprises at least about 40% of the sugar alcohol, preferably at least about 50%, more preferably at least about 70%, most preferably at least about 85%, based on the weight of the dosage form.

As used herein, “nicotine active” refers to one or more compounds selected from nicotine, derivatives of nicotine such as salts and nicotine complexes, tobacco extract or leaf, and other pharmacologically active compounds which are useful for reducing cravings for nicotine, such as lobeline. As used herein, “cravings for nicotine” include cravings associated with tobacco usage, such as smoking and chewing tobacco.

A variety of nicotine actives are well known in the art and are commercially available. Specific examples of nicotine actives suitable for use in the present invention include nicotine oil, nicotine bitartrate, and nicotine complexed with cyclodextrin or polymer resins (e.g., nicotine polacrilex). Preferred nicotine actives are nicotine bitartrate, nicotine polacrilex, nicotine oil, and combinations thereof, especially nicotine bitartrate. The nicotine active may be used in one or more distinct physical forms well known in the art, including free base forms, encapsulated forms, ionized forms, and spray-dried forms.

The oral dosage form comprises one or more nicotine actives in an amount effective to reduce nicotine cravings, preferably within one hour of starting oral administration. In preferred embodiments, the product configuration, including the amount of nicotine active, is effective to reduce nicotine cravings either rapidly (e.g., within about 10 minutes, preferably within about 5 minutes), over a prolonged period (e.g., at least about 1 hour, preferably at least about 2 hours), or both, preferably both. Such combined rapid and prolonged craving relief may result from either the nicotine active per se or a combination of the nicotine active with other means which reduce acute or extended nicotine cravings (e.g., non-pharmacological sensory signals (including taste, tactile, scent signals) provided by inert components, such as flavor, cooling, tingling, effervescence). For example, the composition may comprise one or more flavors to provide rapid craving relief and an amount of nicotine active effective to provide relief of prolonged cravings.

In general, the amount of nicotine active may vary depending on the recommended or permitted therapeutic dosage for the particular nicotine active. Such dosages are known or ascertainable by conventional methods by those skilled in the medical arts. The composition preferably comprises from about 0.5 mg to about 5 mg of nicotine active per unit dosage form, more preferably from about 1 to about 4 mg nicotine active per unit dosage form.

The nicotine active is preferably substantially contained in the glassy matrix, and may be uniformly distributed throughout the matrix or distributed in one or more regions of the matrix.

The oral dosage form of the present invention may contain one or more optional ingredients, including ingredients such as are known in the art, e.g., buffers, flavorings, sugars, other sugar alcohols, high intensity sweeteners, colorants, vitamins, and antioxidants. Such optional ingredients may be used as adjuvants or as co-carriers for the nicotine active and optional components (e.g., sugars and sugar alcohols may be a co-carrier).

One or more buffer materials are especially desirable to facilitate transmucosal absorption of nicotine actives such as nicotine and nicotine derivatives. The buffer provides an alkaline mouth saliva pH that tends to enhance transmucosal absorption of such nicotine actives. Suitable buffer materials include inorganic or organic bases which have the capability to provide a mouth saliva pH of from above 7.0 to about 12.0, preferably above 7.0 to about 11.0, more preferably from about 7.5 to about 10.0, also about 7.5 to about 9.0. Suitable buffer materials include sodium carbonate, sodium bicarbonate, calcium carbonate, potassium carbonate, potassium bicarbonate, sodium phosphate dibasic, sodium phosphate tribasic, potassium phosphate dibasic and potassium phosphate tribasic. The buffer preferably comprises sodium carbonate, potassium carbonate, or a mixture thereof.

Preferably sufficient buffer is used such that the mouth saliva pH becomes and remains alkaline while the oral dosage form is held in the mouth during oral administration. When used, the composition generally comprises from about 0.2% to about 5.0% (e.g., about 0.5% to about 1.5%) buffer.

One or more sugars or-other sugar alcohols may be used, e.g., as bulking agents. It has been found that such other sugar components may reduce the processing temperature required to form the oral dosage form, thereby tending to maintain stability of nicotine actives such as nicotine and its derivatives, and to increase the cost effectiveness of the process. Suitable other sugar components include sucrose, sorbitol, and xylitol, and in a preferred embodiment is sorbitol.

It is preferred that the oral dosage form is itself substantially non-hygroscopic and glassy. Therefore, the type and amount of optional other sugar components will preferably be selected such that the oral dosage form is substantially non-hygroscopic and glassy. In preferred embodiments, the oral dosage form absorbs a maximum of about 30% water by weight, more preferably a maximum of about 20% water by weight, even more preferably a maximum of about 10% by weight (e.g., up to about 8% by weight), still more preferably a maximum of about 5% by weight (especially a maximum of about 1-2% by weight), upon exposure to conditions of 25C/80% rh for a period of 2 weeks. Typically the oral dosage form will comprise from 0% to about 20%, e.g., from about 1% to about 20% or from about 10% to about 20% of such other sugar components, inclusive of any such components that may be present in the required sugar alcohol component. The composition may comprise higher levels of such other sugar components, provided that the matrix structure and hygroscopicity are acceptable.

High intensity sweeteners are useful for improving the sweetness profile of the composition, e.g., to provide a sweetness degree similar to table sugar. High intensity sweeteners are well known in the art and include soluble saccharin salts (e.g., sodium, calcium salts), the free acid form of saccharin, cyclamate salts, aspartame, Acesulfame-K (the potassium salt of 3,4-dihydro-6-methyl-1,2,3-oxathiazine-4-one-2,2-dioxide), and sodium, ammonium, or calcium salts of 3,4-dihydro-6methyl-1,2,3-oxathiazine-4-one-2,2-dioxide. Preferred high intensity sweeteners are Acesulfame-K and aspartame, especially Acesulfame K. High intensity sweeteners, when used, typically comprise from about 0.001% to about 5% of the composition, more typically up to about 0.5% by weight of the composition.

Flavoring agents may be any natural or synthetic flavors such as known in the art, including mints (e.g., peppermint, spearmint), menthol, citrus (e.g., orange, lemon), other fruit flavors, vanilla, cinnamon, chocolate, and tobacco flavor. When used, the composition typically comprises a total of from about 0.5 to about 5 weight % of one or more flavorings.

Colorants include pigments, natural food colors and dyes which are suitable for food and drug applications, e.g., F.D.C. dyes and lakes. Colorants typically comprise from about 0.001% to about 0.05% of the composition.

Vitamins such as vitamin C and E may be included.

Small amounts of vegetable oils, e.g., sesame oil, may be added to the composition as a processing aid, more particularly as an anti-adhesive agent/lubricant to prevent the composition from sticking to equipment, molds, and the like. Typically up to about 1% of such oils, based on the weight of the composition, may be used.

Small amounts of citric acid may be included, e.g., to prevent discoloration of the composition during processing.

In further embodiments, the oral dosage form of the present invention may be substantially free or essentially free of water-soluble gelling agents (e.g., guar gum, gum arabic, and the like), and/or substantially free or essentially free of zinc. In this respect, “essentially free” means such ingredients are not intentionally added.

The solid oral dosage forms may also contain pharmaceutically acceptable polymers and binders and/or mixtures of such polymers and binders. Such polymers ad binders include, but are not limited to:

Homo- or copolymers of N-vinylpyrrolidone such as polyvinylpyrrolidone (PVP), copolymers of N-vinylpyrrolidone with vinylesters, especially with vinylacetate, or also with vinylpropionate. Copolymers of vinylacetate and crotonic acid, partly saponified polyvinylacetate or polyvinylalcohol;

Cellulose derivatives such as, cellulose ether, especially methyl cellulose, ethyl cellulose, hydroxyalkyl celluloses, especially hydroxypropyl cellulose, hydroxyalkyl alkyl celluloses, especially hydroxypropyl methyl cellulose and hydroxypropyl ethyl cellulose. Cellulose esters such as cellulose phthalate;

Also suitable as polymer binders are polymers with an acrylate or methacrylate base, for example the polyacrylates and polymethacrylates, copolymers of acrylic acid and methylmethacrylate or polyhydroxyalkyl acrylates or methcrylates;

Also suitable are polyactides, polyglycolides, polyactide-polyglycolides, polydioxans, polyanhydrides, polystyrene sulfonates, polyacetates, polycaprolactones, poly(ortho)esters, polyamines, polyhydroxyalkanoates or alginates;

Suitable matrix components may also be natural or semi-synthetic binders such as starches, decomposed starches, for example maltodextrine, as well as gelatin which may have a basic or acidic character as required, chitin or chitosan.

Mixtures of polymers and binders may be used. Especially preferred mixtures include thermoplastically processable polymers with Isomalt.

The solid, oral dosage forms may be suitably prepared by methods known in the art of hard confectionaries, e.g., hard-boiled confectionaries. A general discussion of preparation of hard confectionaries may be found in H. A. Lieberman, Pharmaceutical Dosage Forms: Tablets, Vol. 1 (1980), Marcel Dekker, Inc., N.Y., N.Y., especially pp. 339-469. Particular apparatus for making the oral dosage form includes cooking and mixing apparatus known in the confectionary manufacturing arts, and appropriate apparatus will be apparent to the skilled artisan.

In general, preparation of the solid, oral dosage form involves:

(1) with mixing and heating, forming a melt of the substantially non-hygroscopic sugar alcohol and optionally, other sugar components and/or a diluent such as water;

(2) cooking the melt;

(3) removing excess moisture from the melt (e.g., to less than about 2% moisture);

(4) cooling the melt with mixing until the melt is a plastic-like, workable mass;

(5) while the melt is a plastic-like mass, incorporating the nicotine active and any remaining optional ingredients; and

(6) forming the plastic-like mixture into solid, oral dosage forms having the desired size and shape.

Methods known in the art of making hard confectionaries include those utilizing fire cookers, vacuum cookers, and scraped-surface cookers (aka high speed atmospheric cookers).

E.g., in one suitable fire cooker method, the desired quantity of the substantially non-hygroscopic sugar alcohol and any other sugar components are dissolved in water by heating them in a kettle until dissolved. Additional sugar components may be added and cooking continued until a final temperature of about 145-165° C. is achieved. The mix is then cooled, worked as a plastic-like mass, and admixed with the nicotine active and optional ingredients such as flavors, colorants, buffer, etc.

E.g., in one suitable vacuum cooker method, the sugar components are boiled at a temperature of about 125-132° C., vacuum is applied and additional water is boiled off without extra heating. When cooking is complete, the mass is a semi-solid having a plastic-like consistency. The nicotine active and any optional ingredients are admixed into the mass at this point by conventional methods.

E.g., in one suitable method using scraped-surface cookers, a film of a mixture of the sugar components is spread on a heat exchange surface and heated to about 165-170° C. within a few minutes. The composition is then rapidly cooled to about 100-120° C. and worked as a plastic-like mass, mixing in the nicotine active and any optional ingredients.

In the foregoing methods, the cooking temperature should be sufficiently high to drive water from the mix. Where vacuum is employed, lower temperatures can typically be used. In order to avoid discoloration of the sugar components, the buffer is preferably added at a temperature below 130° C., e.g. from 80° C. to 130° C., more preferably between 120° C. and 125° C. In order to facilitate formation of a transparent product, the buffer is preferably added as a solution. The nicotine active is preferably added as a preblend comprising a sugar or sugar alcohol component, to help ensure uniform dosage. The ingredients are mixed for a period to provide a homogeneous mixture, typically from about 4 to about 10 minutes. Once the composition has been properly tempered, it may be cut into workable portions or otherwise formed into desired shapes and sizes using forming techniques such as are known in the art.

The process of preparation can be adapted by those skilled in the art to provide solid dosage forms having a desired configuration, including single-layer, multi-layer having two or more layers (e.g., 3 layers), and forms having a center core. For example, the nicotine active may be distributed in one or more layers, in a portion of a layer, included in a center core (e.g., surrounded wholly or in part by another composition, preferably comprising the glassy matrix), or otherwise concentrated in one or more regions of the oral dosage form.

In preferred embodiments the oral dosage form is configured such that the buffer and nicotine active are substantially separated, e.g., to reduce the potential for reaction between the active and buffer. Such embodiments are preferably configured to facilitate transmucosal absorption of the nicotine active, e.g., such that the buffer and nicotine active are released approximately simultaneously. For example, the buffer and nicotine may be present in separate outer layers of the oral dosage form, optionally with one or more other layers sandwiched therebetween. Such sandwich layers are preferably inert to the buffer and nicotine active. Alternatively, either the buffer or nicotine active may be present in a center core, with the other component, respectively, being present in a composition, preferably comprising the glassy matrix, surrounding the core wholly or in part (e.g., in an outer ring encircling the core). In another embodiment, the buffer may be included in a portion of a layer, with the nicotine active being included in another, separate portion of the layer (e.g., half buffer, half active).

The oral dosage form of the present invention is useful as a tobacco replacement, and as a means to reduce or stop tobacco use, including smoking tobacco (cigarettes, pipe tobacco, cigars), and chewing tobacco. The oral dosage form may be used as a total or partial replacement of tobacco, and can be used concurrently with tobacco in a planned tobacco reduction program (e.g., while reducing tobacco usage prior to quitting tobacco usage).

Therefore, the present invention also relates to a method of reducing tobacco usage, comprising orally administering a solid, oral dosage form of the present invention to a person in need of such reduction. The present invention also relates to a method of reducing nicotine cravings comprising orally administering a solid, oral dosage form of the present invention to a person in need of nicotine craving reduction. “Need” is intended to include a person's desire to reduce tobacco usage or nicotine cravings, respectively. Reducing nicotine cravings or tobacco usage includes stopping nicotine cravings or tobacco usage, respectively.

In general, in these methods the oral dosage form is administered as needed to prevent or reduce nicotine cravings, within any recommended or permitted limits. The oral dosage form is typically administered such that the nicotine active is primarily delivered transmucosally in the mouth. Useful regimens may include those which provide a sustained nicotine blood plasma concentration of from about 6 ng/ml to about 35 ng/ml. Fast craving relief may be perceived by users where, for example, the composition is configured to provide a nicotine blood plasma concentration of at least about 6 ng/ml, especially at least about 12 ng/ml, within about 10 minutes of starting administration, especially within about 5 minutes of starting administration.

For example, for lozenge forms, up to about 15 lozenges comprising 4 mg nicotine or its equivalent may be used per day. The number of lozenges used per day may be adjusted upward or downward for lower or higher unit dosage strengths, respectively, to provide equivalent regimens.

### EXAMPLES

Without further elaboration, it is believed that one skilled in the art can, using the preceding description, utilize the present invention to its fullest extent. The following Examples, therefore, are to be construed as merely illustrative and not a limitation of the scope of the present invention.

### Example 1

A nicotine lozenge is prepared as follows. In a 500 ml beaker, combine 100 grams of ISOMALT powder, 25 grams of water and 0.4 gram of menthol. While mixing, heat the mixture using a hot plate until all the ISOMALT melts. Continue mixing and heat to about 165° C. Reduce the temperature to about 120° C., with continuous mixing. At about 120° C., add about 1.2 grams of sodium carbonate to adjust the pH to from about 7.5 to about 9.0 (pH can be determined on a solution of 0.1 gram of the mixture in 10 ml of DI water), and any other desired optional ingredients, e.g., flavors and/or vitamins. Add 185 mg nicotine bitartrate dihydrate salt (equivalent to 60 mg of nicotine free base) to the mixture at about 120° C., mix well and keep the melted mixture at about 120° C. Push the mixture through a candy former to produce nicotine lozenges. The mixture can alternatively be deposited into suitable molds, cooled, and demolded to provide nicotine lozenges. By the time of solidification, most of the water used for processing will have evaporated, with only residual water remaining.

### Example 2

4 mg-nicotine lozenges having the following formulations A and B are prepared.

| | % w/w |
|---|---|
| Formula A ingredients: | |
| nicotine polacrilex (18% w/w nicotine | 0.47 |
| potency) | |
| sodium carbonate anhydrous, NF | 1.70 |
| ISOMALT Type M | 96.83 |
| sesame oil, NF | 1.0 |
| Formula B ingredients: | |
| nicotine bitartrate dihydrate (33% w/w | 0.86 |
| nicotine potency) | |
| sodium carbonate anhydrous, NF | 1.70 |
| ISOMALT Type M | 96.44 |
| sesame oil, NF | 1.0 |

Mix the ISOMALT with purified water in a ratio of 75% ISOMALT and 25% water by weight. While mixing, heat the ISOMALT/water mixture until all the ISOMALT melts. Continue mixing and heat to about 165° C. Reduce the temperature to about 120° C., with continuous mixing. At about 120° C., add the sodium carbonate to adjust the pH to from about 7.5 to about 9.0 (pH can be determined on a solution of 0.1 gram of the mixture in 10 ml of DI water), the nicotine ingredient, and sesame oil. Keep the melted mixture at about 120° C. and form into lozenges using suitable molds.

By the time of solidification of the lozenge, most of the water used for processing will have evaporated, with only residual water remaining.

### Example 3

The in vitro dissolution profile of a lozenge is determined utilizing a VanKel model VK 7000 Dissolution Bath under the following conditions:

a. USP apparatus I (Basket).

b. Dissolution media: 900 ml of USP phosphate buffer (pH=7.4).

c. Dissolution temperature: 37° C.+/−0.5° C.

d: Shaft rotational speed: 100 rpm.

e. Samples are collected in the amount of 2 ml by an automated sampling device, for each vessel, at each desired time interval (e.g., 5, 10, 20 and 30 minutes, and 1, 2, 3, 4, 5, 6, 7 and 8 hours until 100% or steady-state release is achieved). Replace the removed media with 2 ml phosphate buffer at each time interval.

f. Samples are directly analyzed for nicotine content by HPLC methodology.

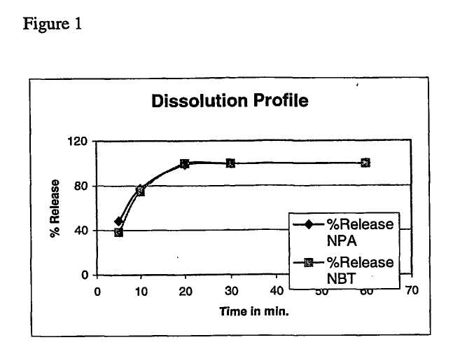

A lozenge prepared in accordance with Example 2 provided an in vitro dissolution profile as shown in FIG. 1. As shown in FIG. 1, nicotine is completely released within about 20 minutes; at least about 50% is released within about 10 minutes of starting in vitro dissolution. The present invention therefore potentially provides a nicotine lozenge that exhibits an in vivo nicotine release profile substantially the same as shown in FIG. 1, after starting oral administration. Preferably, substantially all of the released nicotine is transmucosally absorbed.

### Example 4

Pre-blend together 75 g xylitol powder, 56 g of nicotine bitartrate dihydrate, 9 g aspertame and 16 g menthol. Separately, combine 300 g ISOMALT M, 80 g purified water, 0.8 g citric acid and 0.1 g Acesulfame. Prepare buffer solution by dissolving 3 grams of sodium carbonate in 12 ml of hot water (100° C.). Mix the ISOMALT mixture well and while mixing, heat quickly to 165° C., preferably within about 10 minutes. Cool to 135° C. To 200 g of the cooked mix, add 1.45 g of the xylitol/nicotine bitartrate pre-blend, then the hot buffer solution, and mix well. Cool to 80° C. and cut into a desired oral dosage form.

What is claimed is:

1. A solid, oral dosage form useful for transmucosal oral administration of a nicotine active, comprising:
a) a glassy matrix comprising at least one substantially non-hygroscopic sugar alcohol capable of forming a glassy structure; and
b) a nicotine active in an amount effective to reduce nicotine cravings.

2. A dosage form of claim 1 wherein the sugar alcohol comprises a mixture of 1,6-GPS (6-O-α-D-glucopyranosyl-D-sorbitol) and 1,1-GPM (1-O-α-D-glucopyranosyl-D-mannitol) in a weight ratio of from about 99:1 to about 1:99.

3. A dosage form of claim 1 comprising at least about 50% of the sugar alcohol, based on the weight of the dosage form.

4. A dosage form of claim 1 wherein the nicotine active is selected from nicotine, derivatives of nicotine, and combinations thereof.

5. A solid, oral dosage form useful for transmucosal oral administration of a nicotine active, comprising:
a) a glassy matrix comprising at least about 50%, based on the weight of the dosage form, of a sugar alcohol mixture comprising 1,6-GPS (6O-α-D-glucopyranosyl-D-sorbitol) and 1,1-GPM (1-O-α-D-glucopyranosyl-D-mannitol) in a weight ratio of from about 99:1 to about 1:99; and
b) a nicotine active in an amount effective to reduce nicotine cravings, selected from nicotine, derivatives of nicotine, and combinations thereof.

6. A dosage form of claim 2 or 5 wherein the sugar alcohol comprises a mixture of 1,6-GPS and 1,1-GPM in a weight ratio of from about 70:30 to about 30:70.

7. A dosage form of claim 6 wherein the sugar alcohol comprises a mixture of 1,6-GPS and 1,1-GPM in a weight ratio of from about 60:40 to about 40:60.

8. A dosage form of claim 7 wherein the sugar alcohol mixture is ISOMALT.

9. A dosage form of claim 4 or 5 further comprising a buffer in an amount effective to provide an alkaline mouth saliva pH.

10. A solid, oral dosage form useful for transmucosal oral administration of a nicotine active, comprising:
a) a glassy matrix comprising at least about 50%, based on the weight of the dosage form, of a sugar alcohol mixture which is ISOMALT;
b) a nicotine active in an amount effective to reduce nicotine cravings, selected from nicotine, derivatives of nicotine, and combinations thereof; and
c) a buffer in an amount effective to provide an alkaline mouth saliva pH.

11. A dosage form of claim 3, 5 or 10 comprising at least about 70% of the sugar alcohol mixture, based on the weight of the dosage form.

12. A dosage form of claim 11 comprising at least about 85% of the sugar alcohol mixture, based on the weight of the dosage form.

13. A dosage form of claim 4, 5 or 10 wherein the nicotine active is selected from nicotine oil, nicotine bitartrate, nicotine polacrilex and combinations thereof.

14. A dosage form of claim 4, 5 or 10 comprising from about 0.5 mg to about 5 mg of the nicotine active per dosage unit.

15. A dosage form of claim 9 or 10 wherein the buffer is selected from sodium carbonate, sodium bicarbonate, calcium carbonate, potassium carbonate, potassium bicarbonate, sodium phosphate dibasic, sodium phosphate tribasic, potassium phosphate dibasic, potassium phosphate tribasic, and combinations thereof.

16. A dosage form of claim 15 wherein the buffer is selected from sodium carbonate, potassium carbonate, and combinations thereof.

17. A dosage form of claim 3, 5 or 10 wherein the glassy matrix further comprises from about 1% to about 20%, based on the weight of the dosage form, of one or more compounds selected from the group consisting of sucrose, sorbitol, and xylitol.

18. A dosage form of claim 1, 5 or 10 further comprising a non-pharmacological component for providing a sensory signal effective to provide rapid nicotine craving relief.

19. A dosage form of claim 1, 5 or 10 in the form of a lozenge.

20. A method of reducing nicotine cravings comprising orally administering a dosage form of claim 1, 5 or 10 to a person in need of nicotine craving reduction.

21. A method of claim 20 wherein a nicotine active blood plasma concentration of at least about 6 ng/ml is achieved after starting oral administration of the dosage form.

22. A method of claim 20 wherein a sustained nicotine active blood plasma concentration of from about 6 ng/ml to about 35 ng/ml is achieved after starting oral administration of the composition.

23. A method of claim 21 or 22 wherein the nicotine active is selected from nicotine, derivatives of nicotine, and combinations thereof.

24. A method of reducing tobacco usage comprising orally administering a dosage form of claim 1, 5 or 10 to a person in need of reducing tobacco usage.

25. A solid, oral dosage form useful for transmucosal oral administration of a nicotine active, wherein the dosage form provides a nicotine active blood plasma concentration of at least about 6 ng/ml after starting oral administration of the dosage form.

26. A solid, oral dosage form useful for transmucosal oral administration of a nicotine active, wherein the dosage form provides a sustained nicotine active blood plasma concentration of from about 6 ng/ml to about 35 ng/ml after starting oral administration of the dosage form.

27. A dosage form of claim 25 or 26 wherein the nicotine active is selected from nicotine, derivatives of nicotine, and combinations thereof.
